(19) United States
(12) Patent Application Publication
(10) Pub. No.: US 2026/0226951 A1
(43) Pub. Date: Aug. 6, 2026

(54) DRUM-IN-HAT BRAKE ASSEMBLY

(71) Applicant: CCYS HI-TECH INTERNATIONAL LTD., TAICHUNG CITY (TW)

(72) Inventor: SHENG-YU WANG, TAICHUNG CITY (TW)

(73) Assignee: CCYS HI-TECH INTERNATIONAL LTD., TAICHUNG CITY (TW)

(21) Appl. No.: 19/169,367

(22) Filed: Apr. 3, 2025

(30) Foreign Application Priority Data
Feb. 6, 2025 (TW) 114201258

(51) Int. Cl. F16D 65/12; F16D 65/02

(52) U.S. Cl. CPC F16D 65/123; F16D 2065/1316; F16D 2065/1392

(57) ABSTRACT

A drum-in-hat brake assembly includes a drum ring including an inner circumferential surface for being abutted by drum brake shoes, and drum combining holes located therearound, a disc including a central hole, which the drum ring is at least partially located in, and has an inner wall with disc combining holes, a connecting seat connected with the drum ring, partially located in and partially protruding out of the central hole of the disc, and including a central region for being fastened with axle bolts, and seat combining holes located therearound, and fasteners inserted in the drum combining holes, disc combining holes and seat combining holes to fixedly combine the drum, disc and connecting seat. The specific gravity of the material of the connecting seat is smaller than that of the drum ring. The overall structure is lightweight, and great in structural rigidity and wear resistance.

### BACKGROUND OF THE INVENTION

### 1. Field of the Invention

The present invention relates generally to brake systems and more particularly, to a drum-in-hat brake assembly.

### 2. Description of the Related Art

The conventional drum-in-hat park brake assembly includes a drum for a drum brake, and a disc for a disc brake. The drum is disposed at the center of the disc to form a hat-like structure. The drum has an inner circumferential surface for brake shoes to be abutted thereon for friction, and an end surface for being fastened with axle bolts. Traditionally the drum and the disc are integrally formed by casting or forging, or the drum and the disc are separately made by casting or forging and then welded together or fastened together by bolts.

Because the drum has to bear the friction and abutting force from the brake shoes and has to be provided with quite high structural strength, traditionally the drum is made of cast iron, thereby heavy in weight. That not only increases the overall weight of the vehicle, but also affects the transmission efficiency, thereby requiring improvement. Besides, firmly combining the drum and the disc together in a way of facilitating the assembly and disassembly is also an aim that the industry works on.

### SUMMARY OF THE INVENTION

The present invention has been accomplished in view of the above-noted circumstances. It is an objective of the present invention to provide a drum-in-hat brake assembly, which is lightweight in overall structure, and has great structural rigidity and wear resistance.

It is another objective of the present invention to provide a drum-in-hat brake assembly, which is stable in assembled structure, and easy to be assembled and disassembled.

To attain the above objective, the present invention provides a drum-in-hat brake assembly which includes a drum ring, a disc, a connecting seat, and a plurality of fasteners. The drum ring includes an inner circumferential surface for being abutted by a drum brake shoe, and a plurality of drum combining holes located around the inner circumferential surface. The disc is adapted for being abutted by a disc brake pad, and includes a central hole and a plurality of disc combining holes located on an inner wall of the central hole. The connecting seat includes a central region for being fastened with an axle bolt, and a plurality of seat combining holes located around the central region. The specific gravity of the material of the connecting seat is smaller than the specific gravity of the material of the drum ring. The plurality of fasteners are inserted in the drum combining holes of the drum ring, the disc combining holes of the disc, and the seat combining holes of the connecting seat to fixedly combine the drum ring, the disc and the connecting seat in a way that at least a part of the drum ring is located in the central hole of the disc, and the connecting seat is coupled with the drum ring and has a part located in the central hole of the disc and another part protruding out of the central hole.

As a result, the drum ring and the connecting seat provided in the present invention can be combined into a drum similar to that in the traditional drum-in-hat brake assembly. That is, the inner circumferential surface of the drum ring is adapted for the brake shoes to be abutted thereon for friction, and the connecting seat is utilized to fixedly connect the drum ring with the disc, and adapted for being fastened with the axle bolts. Besides, for the drum-in-hat brake assembly of the present invention, the specific gravity of the material of the connecting seat is smaller than the specific gravity of the material of the drum ring. For example, the material of the connecting seat is aluminum alloy, and the material of the drum ring is cast iron. Compared with the conventional drum integrally made of cast iron, the drum in the present invention, which is the combination of the drum ring and the connecting seat, is lighter in overall weight. Besides, the drum ring made of the material with relatively larger specific gravity can provide the drum the desired rigidity and wear resistance, so that the objective of the present invention is achieved.

Preferably, the material of the drum ring is cast iron or steel, the material of the disc is cast iron, steel, or a composite of ceramic and carbon fiber, and the material of the connecting seat is aluminum alloy. As a result, the connecting seat made of aluminum alloy can make the overall structure lightweight. The drum ring made of cast iron or steel can make the drum have high rigidity and wear resistance.

Preferably, the drum ring includes a ring body, and a fastening ring plate annularly connected to the ring body and extending horizontally and radially. The inner circumferential surface is provided at the ring body. The drum combining holes penetrate through the fastening ring plate. By the configuration design of the fastening ring plate, the fastening ring plate can be in face-to-face contact with the inner wall of the central hole of the disc, which makes the drum ring, the disc and the connecting seat easier to be combined or detached, and can make them fastened together firmly.

Preferably, the inner wall of the central hole of the disc has a plurality of protrusions. The protrusions have the disc combining holes. The fastening ring plate of the drum ring is abutted on the protrusions of the disc in a way that the drum combining holes are aimed at the disc combining holes. As a result, the arrangement of the drum ring and the disc is relatively more balanced, which can improve the stability of their combination.

Preferably, the connecting seat includes a seat tube, and a seat room formed in the seat tube. The ring body of the drum ring is accommodated in the seat room of the connecting seat, and is in face-to-face contact with the inner surface of the seat tube. The arrangement that the ring body of the drum ring is accommodated in the seat tube of the connecting seat can protect the ring body of the drum ring, and prevent the ring body of the drum ring from deformation. Besides, the ring body is in face-to-face contact with the inner surface of the seat tube, which makes the drum ring and the connecting seat combined relatively more firmly.

Preferably, the disc includes a plurality of protrusions forming the inner wall of the central hole. The disc combining holes penetrate through the protrusions respectively. The protrusions can improve the structural strength of the disc, and can make the drum ring and the disc combined and fastened relatively more firmly.

Preferably, the fastener includes a bolt and a nut. The bolt is inserted through the drum combining hole of the drum ring, the disc combining hole of the disc and the seat combining hole of the connecting seat, and screwed into the nut, so that the drum ring, the disc and the connecting seat are clamped between a head portion of the bolt and the nut. As a result, the drum ring, the disc and the connecting seat can be combined and fastened firmly.

Preferably, the fastener includes a bolt, a sleeve, a spacer, and a nut. The spacer is clamped between a rear surface of the disc and a front surface of the connecting seat, and includes a spacer through hole. The sleeve includes an abutment portion and an insertion portion connected with each other, and a sleeve through hole penetrating through the abutment portion and the insertion portion. The insertion portion of the sleeve is disposed in the disc combining hole, the seat combining hole, and the spacer through hole. The bolt includes a head portion and a rod portion connected with each other. The rod portion is inserted through the sleeve through hole, and includes a threaded section. The nut is fixedly screwed onto the threaded section, so that the drum ring, the disc, the spacer, the connecting seat and the abutment portion of the sleeve are clamped between the head portion of the bolt and the nut.

Preferably, the sleeve of the fastener includes two grooves formed at the abutment portion. Each of the seat combining holes includes a recess. The recess has an inner bottom surface. An inner edge of the inner bottom surface is accommodated in the groove, which enables the sleeve of the fastener to be perfectly abutted on the connecting seat.

Preferably, the sleeve of the fastener includes two installation planes opposite to each other. The installation planes are accommodated in the seat combining hole of the connecting seat. As a result, the installation of the sleeve to the connecting seat can be ensured with correct orientation.

Preferably, the spacer of the fastener includes two inner sides formed in the spacer through hole and matched with the installation planes of the sleeve. As a result, the spacer can be ensured with correct orientation with respect to the sleeve and the connecting seat, and the spacer is prevented from rotation.

Preferably, the sleeve of the fastener includes two bumps formed on the installation planes respectively. The bumps of the sleeve are jammed in the seat combining hole of the connecting seat. As a result, the sleeve is prevented from separation from the connecting seat before being fastened.

Further scope of applicability of the present invention will become apparent from the detailed description given hereinafter. However, it should be understood that the detailed description and specific examples, while indicating preferred embodiments of the invention, are given by way of illustration only, since various changes and modifications within the scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is an assembled perspective view of a drum-in-hat brake assembly according to a preferred embodiment of the present invention;

FIG. 2 is another assembled perspective view of the drum-in-hat brake assembly according to the preferred embodiment of the present invention;

FIG. 3 is an exploded perspective view of the drum-in-hat brake assembly according to the preferred embodiment of the present invention;

FIG. 4 is another exploded perspective view of the drum-in-hat brake assembly according to the preferred embodiment of the present invention;

FIG. 5 is a front view of the drum-in-hat brake assembly according to the preferred embodiment of the present invention;

FIG. 6 is a sectional view taken along the line 6-6 in FIG. 5;

FIG. 7 is an enlarged view of a part of FIG. 6;

FIG. 8 is an exploded perspective view of a fastener of the drum-in-hat brake assembly according to the preferred embodiment of the present invention;

FIG. 9 is a sectional view taken along the line 9-9 in FIG. 5; and

FIG. 10 is an enlarged view of a part of FIG. 9.

### DETAILED DESCRIPTION OF THE INVENTION

First of all, it is to be mentioned that same or similar reference numerals used in the following embodiment and the appendix drawings designate same or similar elements or the structural features thereof throughout the specification for the purpose of concise illustration of the present invention.

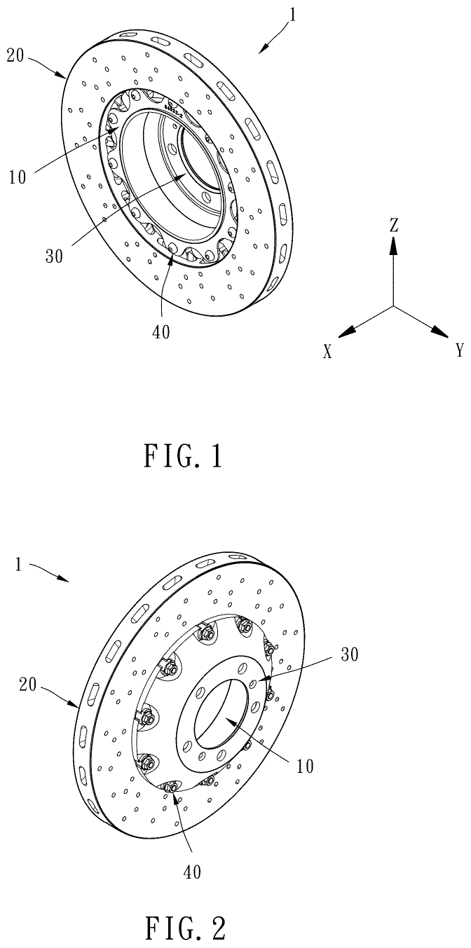

Referring to FIG. 1 and FIG. 2, a drum-in-hat brake assembly 1 according to a preferred embodiment of the present invention includes a drum ring 10, a disc 20, a connecting seat 30, and ten fasteners 40. The present invention is unlimited in amount of the fasteners 40, which can be modified according to structural demands. Besides, the drum ring 10 and the connecting seat 30 in the present invention are combined with each other to form into a drum of the drum-in-hat brake assembly 1 of the present invention.

The drum-in-hat brake assembly 1 is adapted for being fastened to the axle bolts of a vehicle wheel (not shown), and rotated along with the vehicle wheel, thereby defined with a rotary axis, i.e. X-axis shown in the figures. In the present invention, the positive direction of X-axis is defined as a first direction, and the negative direction of X-axis is defined as a second direction. Besides, the word ‘transverse’ mentioned in the present invention refers to any direction perpendicular to the aforementioned rotary axis, i.e. perpendicular to the first direction and the second direction. In other words, the word ‘transverse’ mentioned in the present invention refers to locating on Y-Z plane. Therefore, the transverse size of each component mentioned in the present invention refers to the size such as width or diameter defined on Y-Z plane, and the shape of the transverse cross-section of each component mentioned in the present invention refers to the sectional shape thereof on Y-Z plane.

The present invention is unlimited in shapes of the drum ring 10, the disc 20 and the connecting seat 30.

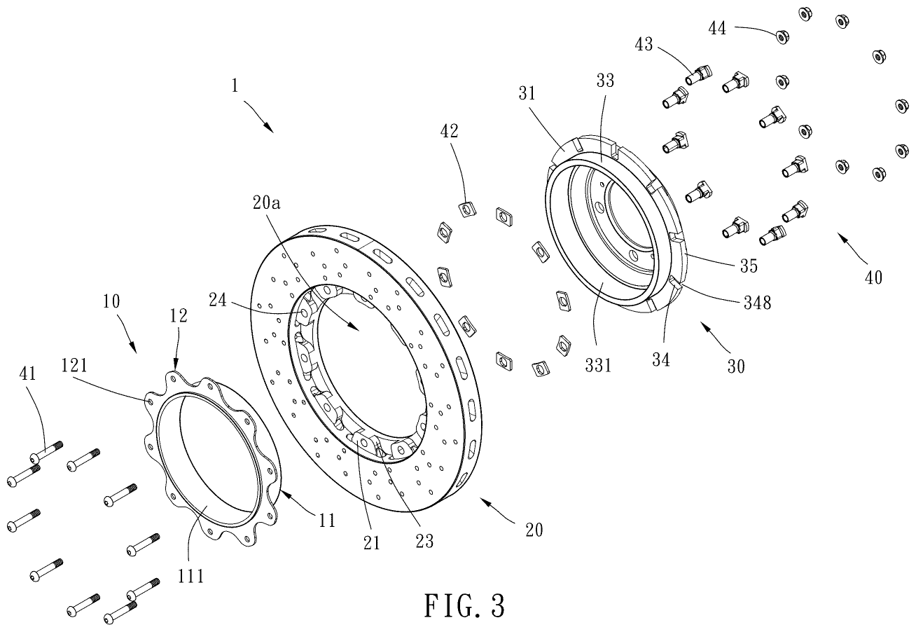

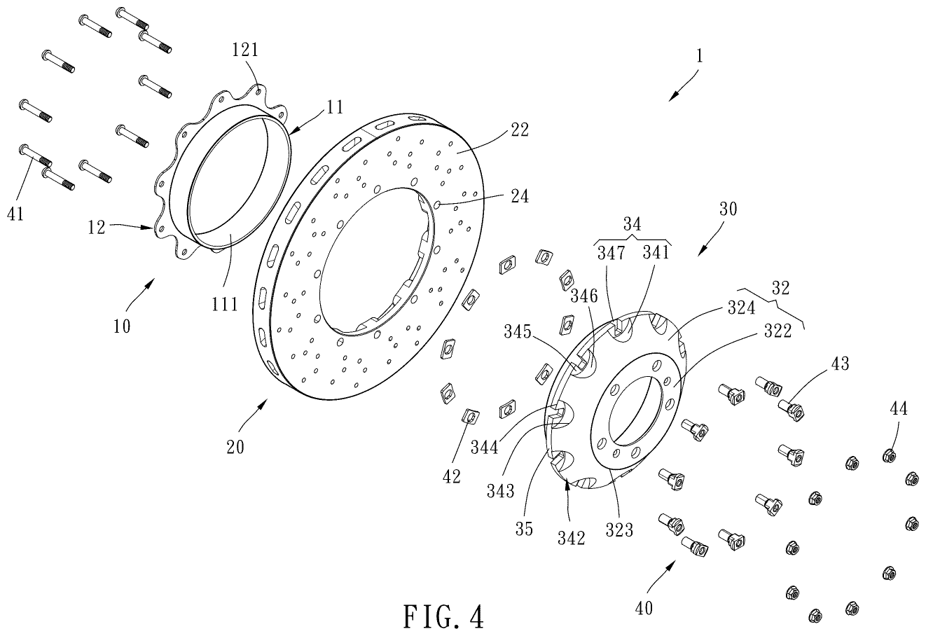

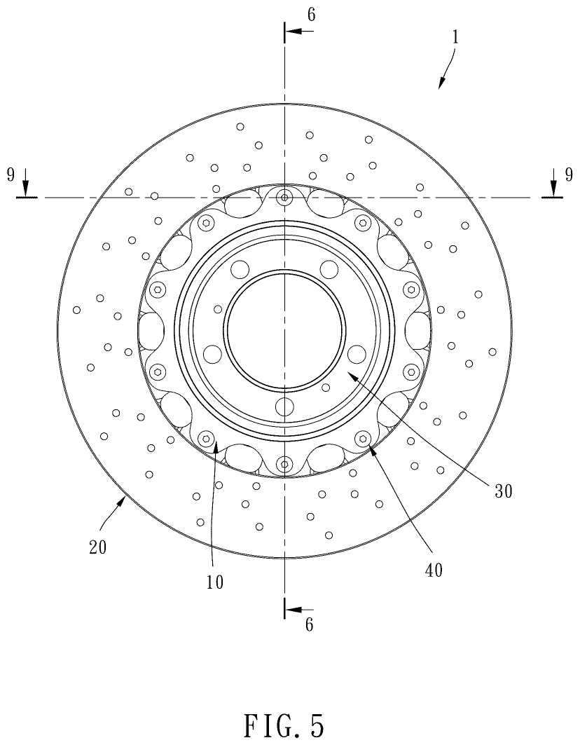

As shown in FIG. 3 and FIG. 4, the drum ring 10 includes a ring body 11, and a fastening ring plate 12 annularly connected to the ring body and extending outward horizontally and radially. The ring body 11 is shaped as a circular tube, thereby formed with an inner circumferential surface 111. The inner circumferential surface 111 is adapted for being abutted by the drum brake shoes of a drum brake (not shown). The fastening ring plate 12 includes a plurality of convex lugs located around the periphery of the ring body 11 in an equally distanced manner, and a plurality of drum combining holes 121 penetrating through the convex lugs respectively. The material of the drum ring 10 is preferable to be the material with relatively larger specific gravity, such as cast iron, steel, and so on, which makes the drum ring 10 have relatively higher rigidity and wear resistance.

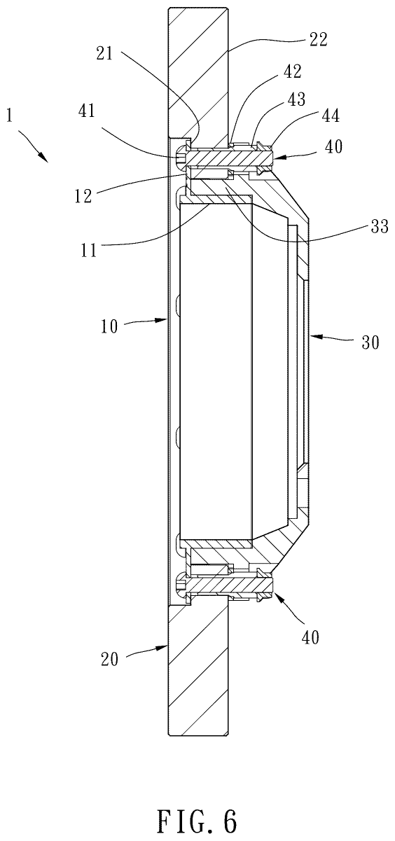

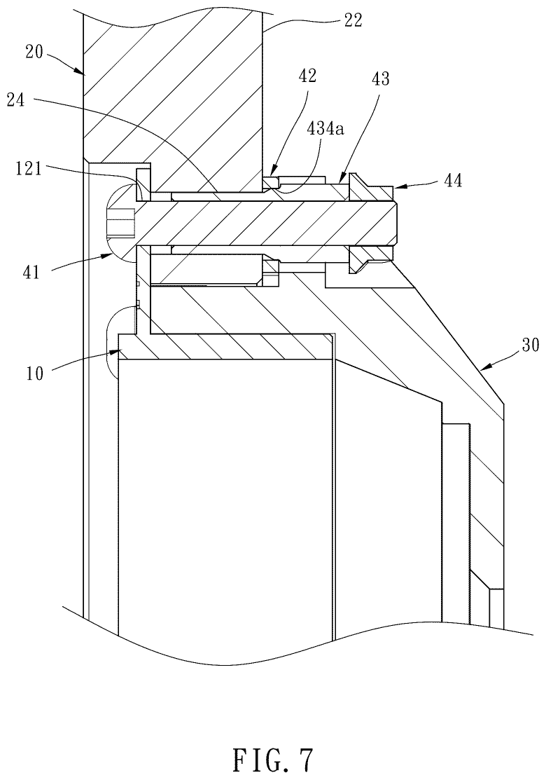

As shown in FIG. 3 and FIG. 4, the disc 20 is adapted for being abutted by the brake pads of a disc brake (not shown). The disc 20 has a central hole 20a. The inner wall of the central hole 20a has a front surface 21 facing toward the first direction (the positive direction of X-axis). The disc 20 has a rear surface 22 facing toward the second direction (the negative direction of X-axis), a plurality of protrusions 23 formed on the inner wall of the central hole 20a and arranged around the axis of the central hole 20a in an equally distanced manner, and ten disc combining holes 24 penetrating through the protrusions 23. The material of the disc 20 may be the general cast iron or steel, or may be a relatively more lightweight composite of ceramic and carbon fiber. That is, the disc may be a cast iron disc, steel disc, or ceramic carbon disc. In this embodiment, the disc 20 with ventilated configuration is adopted. However, the present invention may adopt the disc with solid configuration. During the assembly, as shown in FIG. 6 and FIG. 7, the ring body 11 of the drum ring 10 is inserted into the central hole 20a of the disc 20 in a way that the fastening ring plate 12 of the drum ring 10 is abutted on the protrusions 23 of the disc 20, and the drum combining holes 121 are aimed at the disc combining holes 24, respectively.

As shown in FIG. 3 and FIG. 4, the material of the connecting seat 30 is preferable to be the material with relatively smaller specific gravity, such as aluminum alloy. That is, the specific gravity of the material of the connecting seat 30 should be smaller than the specific gravity of the material of the drum ring 10, such that the drum composed of the connecting seat 30 and the drum ring 10 has a relatively lighter overall structure, thereby achieving the objective of the present invention that the drum is lightweight. Further speaking, the connecting seat 30 includes a front surface 31, a rear surface 32, a seat tube 33, ten seat combining holes 34, and an outer peripheral surface 35. The rear surface 32 includes a central region 322, an outer periphery 323, and a peripheral region 324. The seat tube 33 is connected to the front surface 31, and formed with a seat room 331, as shown in FIG. 3. The inner surface of the seat tube 33 has a stair portion. During the assembly, as shown in FIG. 6 and FIG. 7, the ring body 11 of the drum ring 10 is accommodated in the seat room 331 of the connecting seat 30, the outer surface of the ring body 11 is in face-to-face contact with the inner surface of the seat tube 33, and the stair portion of the inner surface of the seat tube 33 can be stopped at the annular end surface of the ring body 11. In this way, at least a part of the drum ring 10 is located in the central hole 20a of the disc 20, and the connecting seat 30 can be connected with the drum ring 10 firmly. Besides, the connecting seat 30 has a part located in the central hole 20a of the disc 20, and another part protruding out of the central hole 20a. In addition, the seat combining hole 34 includes a recess 341, and an insertion hole 347. The recess 341 includes a recess opening 342, an inner edge 343, an outer edge 344, an inner bottom surface 345, and a recess inner wall 346. The insertion hole 347 includes an opening 348.

The front surface 31 faces toward the first direction. The rear surface 32 faces toward the second direction. The seat combining holes 34 penetrate through the front and rear surfaces 31 and 32. The outer peripheral surface 35 is formed on the outer rim of the peripheral region 324.

The central region 322 of the rear surface 32 of the connecting seat 30 is shaped as a circular ring plane, and has several installation holes for the axle bolts (not shown) to be inserted therein for fastening. The peripheral region 324 is located on the periphery of the central region 322, and slightly arc-shaped. The peripheral region 324 inclinedly extends outward and frontward from the outer periphery 323 of the central region 322 to the outer peripheral surface 35 of the connecting seat 30. The aforementioned word ‘outward’ means leaving the outer periphery 323, and the aforementioned word ‘frontward’ means approaching the front surface 31. The recess 341 of each seat combining hole 34 is recessed from the peripheral region 324 of the rear surface 32 of the connecting seat 30. The recess opening 342 of the recess 341 is located in the peripheral region 324. The inner edge 343 of the recess opening 342 is located relatively closer to the outer periphery 323 of the central region 322. The outer edge 344 is opposite to the inner edge 343 and located at the outer peripheral surface 35 of the connecting seat 30. The inner bottom surface 345 of the recess 341 is connected to the outer edge 344 of the recess opening 342. The recess inner wall 346 extends from the inner edge 343 of the recess opening 342 to the inner bottom surface 345. The insertion hole 347 extends from the inner bottom surface 345 of the recess 341 to the front surface 31 of the connecting seat 30. The openings 348 open the insertion holes 347 of the seat combining holes 34 respectively, and the outer peripheral surface 35.

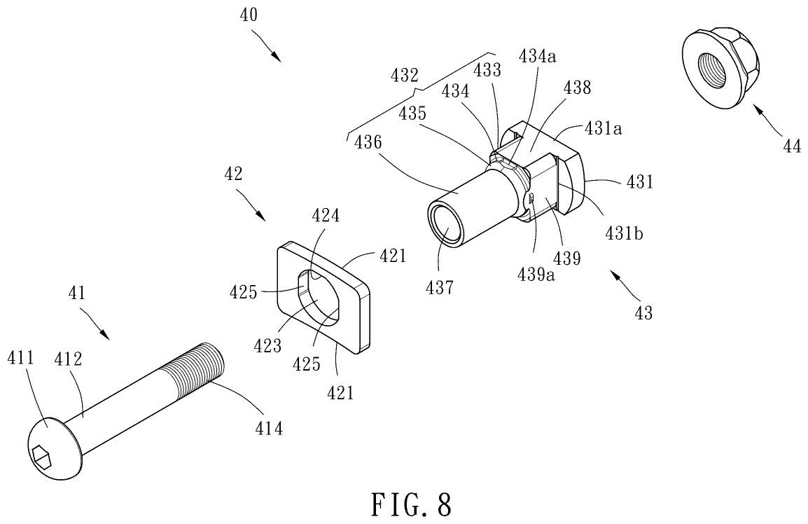

As shown in FIG. 8, each of the fasteners 40 is disposed in the drum combining hole 121 of the drum ring 10, the disc combining hole 24 of the disc 20 and the seat combining hole 34 of the connecting seat 30 to combine the drum ring 10, the disc 20 and connecting seat 30 with each other, which will be specified hereinunder.

As shown in FIG. 8, each fastener 40 includes a bolt 41, a spacer 42, a sleeve 43, and a nut 44. The bolt 41 includes a head portion 411 and a rod portion 412 connected with each other. The rod portion 412 includes a threaded section 414 located at the terminal end of the rod portion 412. The spacer 42 is an approximately rectangular thin sheet with four rounded corners, but two long sides 421 thereof are slightly arc-shaped for matching in shape with the connecting seat 30, but the present invention is unlimited thereto. The spacer 42 includes a spacer through hole 423 located at the center of the spacer 42. The spacer through hole 423 is approximately circular in transverse cross-section, but the inner wall thereof is partially shaped as a plane 424, instead of arc surface, and also partially formed as two inner sides 425 opposite to each other. In other words, the spacer through hole 423 is non-circular. The sleeve 43 includes an abutment portion 431, an insertion portion 432, a sleeve through hole 437, two side planes 438, and two installation planes 439. The insertion portion 432 includes a large insertion section 433, a medium insertion section 434, an inclined section 435 and a small insertion section 436, which are connected in order from the abutment portion 431, and provided from large to small in transverse size in the above-described order. Besides, the sleeve through hole 437 penetrates through the abutment portion 431, the large insertion section 433, the medium insertion section 434, the inclined section 435, and the small insertion section 436. Each installation plane 439 is formed thereon with a bump 439a.

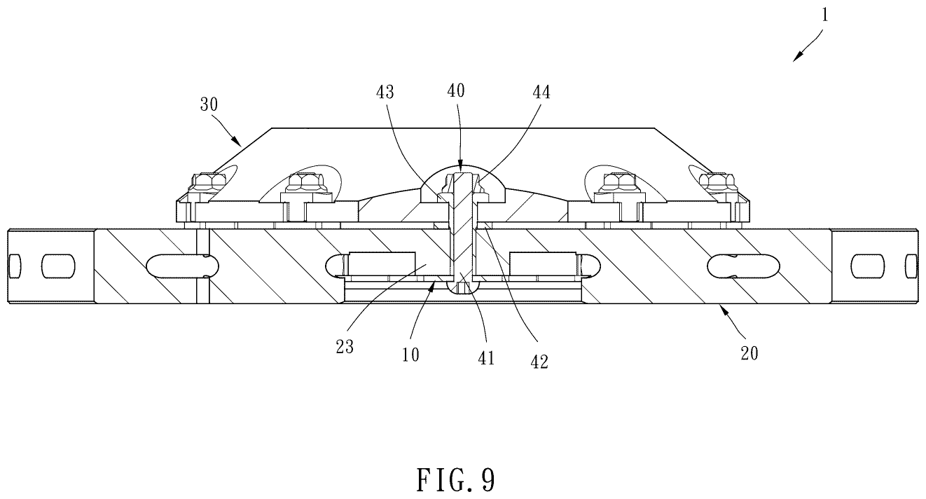

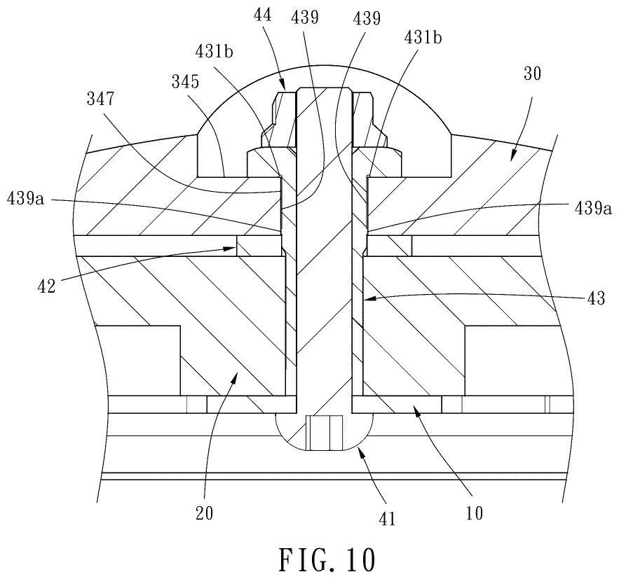

As shown in FIG. 6 to FIG. 10, during the assembly, the insertion portion 432 of the sleeve 43 is inserted from the rear surface 32 of the connecting seat 30 through the seat combining hole 34 of the connecting seat 30 and the spacer through hole 423 of the spacer 42 in order, and inserted into the disc combining hole 24 of the disc 20, so that the large insertion section 433 is located in the seat combining hole 34 of the connecting seat 30, the medium insertion section 434 and the inclined section 435 are located in the spacer through hole 423 of the spacer 42, the small insertion section 436 is located in the disc combining hole 24 of the disc 20, and the spacer 42 is clamped between the rear surface 22 of the disc 20 and the front surface 31 of the connecting seat 30. Then, the rod portion 412 of the bolt 41 is inserted through the sleeve through hole 437 of the sleeve 43 from the drum combining hole 121 of the drum ring 10, and the threaded section 414 of the bolt 41 protrudes from the abutment portion 431 of the sleeve 43. At last, the nut 44 is fixedly screwed onto the threaded section 414 of the bolt 41, so that the head portion 411 of the bolt 41 is abutted against the drum ring 10, the nut 44 is abutted against the connecting seat 30, and the drum ring 10, the disc 20, the spacer 42, the connecting seat 30 and the abutment portion 431 of the sleeve 43 are clamped between the head portion 411 of the bolt 41 and the nut 44. In this way, the drum ring 10, the disc 20 and the connecting seat 30 are combined together firmly. The shape and size relations between each part of the sleeve and each through hole will be specified hereunder.

As shown in FIG. 6 to FIG. 10, the abutment portion 431 of the sleeve 43 is approximately rectangular in transverse cross-section about the same in orientation and size to the spacer 42, but two short sides of the abutment portion 431 are arc-shaped. The large insertion section 433 of the sleeve 43 is approximately rectangular in transverse cross-section but provided with four rounded corners, and two short sides thereof are flush with two long sides of the abutment portion 431 respectively so that they collectively form two side planes 438 of the sleeve 43. In other words, the two side planes 438 are located on two opposite sides of the sleeve 43, and each side plane 438 is simultaneously located at the abutment portion 431 and the large insertion section 433. The two installation planes 439 of the sleeve 43 are perpendicular to the two side planes 438, and located on two sides. The two installation planes 439 are accommodated in the insertion hole 347 of the connecting seat 30. The distance between the two installation planes 439 is smaller than the distance between the two side planes 438, and the installation planes 439 can be abutted on the inner sides 425 of the spacer 42.

When the assembly is accomplished, the large insertion section 433 of the sleeve 43 is disposed in the insertion hole 347 of the seat combining hole 34, the abutment portion 431 of the sleeve 43 is disposed in the recess 341 of the seat combining hole 34 and abutted against the inner bottom surface 345. One of the side planes 438 of the sleeve 43 faces toward the recess inner wall 346 and located closely thereto, and the other side plane 438 does not exceed the outer peripheral surface 35 of the connecting seat 30. Besides, in this embodiment, the outer edge 344 of the recess opening 342 of the recess 341 is directly connected with the opening 348 of the insertion hole 347, enabling the large insertion section 433 of the sleeve 43 to enter the insertion hole 347 of the seat combining hole 34 through the opening 348, thereby convenient for assembly.

In this embodiment, the connecting seat 30 has the part formed by the peripheral region 324, thereby becoming a thicker structure. In this way, the structural strength is relatively higher. Besides, it can be provided with the aforementioned recess 341 for the abutment portion 431 of the sleeve 43 to be positioned in the recess 341, so that the effect of the fastener 40 fastening the disc 20 to the connecting seat 30 is e ven better.

The abutment portion 431 of the sleeve 43 has two opposite planes 431a for matching in shape with the connecting seat 30. Besides, two grooves 431b are formed between the abutment portion 431 and the large insertion section 433. When the assembly is accomplished, the abutment portion 431 is abutted against the inner bottom surface 345 of the connecting seat 30. The large insertion section 433 of the sleeve 43 and the insertion hole 347 of the seat combining hole 34 of the connecting seat 30 are both non-circular in transverse cross-section. For example, they are both approximately rectangular in this embodiment. Such feature can limit the sleeve 43 from rotating relative to the connecting seat 30, thereby making the fastening effect of the fastener 40 even better. The transverse size of the short side of the large insertion section 433 of the sleeve 43 is about equal to the diameter of the spacer through hole 423 of the spacer 42, and the transverse size of the long side of the large insertion section 433 is larger than the diameter of the spacer through hole 423. Therefore, the large insertion section 433 can't enter the spacer through hole 423. The medium insertion section 434 of the sleeve 43 is matched in transverse size with the spacer through hole 423, which means the sizes of them are about equal so that the medium insertion section 434 is just adapted to be inserted in the spacer through hole 423. More specifically speaking, the medium insertion section 434 is approximately circular in transverse cross-section, but three sides thereof are each shaped as a plane 434a, wherein only two of them are shown in FIG. 8. The diameter of the medium insertion section 434 is only a little smaller than the diameter of the spacer through hole 423, and the planes 434a correspond in position and size to the plane 424 of the spacer through hole 423. When the assembly is accomplished, one of the planes 434a of the medium insertion section 434 is in face-to-face contact with the plane 424 of the spacer through hole 423. In other words, the medium insertion section 434 and the spacer through hole 423 are both non-circular in transverse cross-section. Such feature can limit the sleeve 43 and the spacer 42 from rotating relative to each other, thereby making the fastening effect of the fastener 40 even better. The inclined section 435 of the sleeve 43 is circular in transverse cross-section, and the diameter thereof gradually decreases from the medium insertion section 434 to the small insertion section 436. The small insertion section 436 is shaped as a cylinder uniform in diameter, and the diameter thereof is smaller than the diameter of the medium insertion section 434 and about equal to the diameter of the disc combining hole 24 of the disc 20, so that the small insertion section 436 is just adapted to be inserted in the disc combining hole 24.

By the above-described fastener 40, the spacer 42 is clamped between the disc 20 and the connecting seat 30, and the spacer 42 can be made of the material having relatively higher elasticity and can be even made into a warped shape or other elastically deformable shapes, so that in the condition that the front and rear surfaces 21 and 22 of the disc 20 are maintained abutted against the nut 44 and the spacer 42, the elasticity of the spacer 42 makes the disc 20 still slightly movable axially relative to the connecting seat 30, which means the disc 20 is enabled slight floating effect.

In the above-described embodiment, the sleeve 43 is firstly inserted through the seat combining hole 34 of the connecting seat 30 and the spacer through hole 423 of the spacer 42, and then inserted into the disc combining hole 24 of the disc 20, so the seat combining hole 34, the spacer through hole 423 and the disc combining hole 24 are matched in shape with the larger, medium and small insertion sections 433, 434 and 436 and provided from large to small in transverse size. However, the sleeve 43 may be disposed in opposite direction so that the abutment portion 431 of the sleeve 43 is abutted against the front surface 21 of the disc 20, as long as the associated through holes are also modified correspondingly. Besides, the bolt 41 may be disposed in opposite direction, which means the head portion 411 of the bolt 41 and the nut 44 may be positionally exchanged with each other. However, the arrangements of the sleeve 43 and the bolt 41 in the directions as shown in the above-described embodiment are relatively more beneficial to the manufacture and assembly, and can bring relatively better fastening effect.

Besides, the sleeve 43 of the fastener 40 includes the two grooves 431b formed between the abutment portion 431 and the large insertion section 433, so the inner edge of the inner bottom surface 345 of the connecting seat 30 can be accommodated in the grooves 431b, which can make the sleeve 43 of the fastener 40 perfectly abutted on the connecting seat 30.

Besides, the sleeve 43 of the fastener 40 includes the two installation planes 439 perpendicular to the two side planes 438 and opposite to each other. The two installation planes 439 are accommodated in the insertion hole 347 of the connecting seat 30. The distance between the two installation planes 439 is smaller than the distance between the two side planes 438. Therefore, the installation of the sleeve 43 to the connecting seat 30 can be ensured with correct orientation.

In addition, the spacer 42 of the fastener 40 includes the two inner sides 425 formed in the spacer through hole 423 and matched with the installation planes 439 of the sleeve 43. Therefore, the spacer 42 can be ensured with correct orientation with respect to the sleeve 43 and the connecting seat 30, and the spacer 42 is even prevented from rotation.

Furthermore, the sleeve 43 of the fastener 40 includes the two bumps 439a formed on the installation planes 439 respectively. The two bump 439a of the sleeve 43 can be jammed in the insertion hole 347 of the connecting seat 30 to prevent the sleeve 43 from separation from the connecting seat before being fastened.

It should be noticed that the fastener provided in the present invention is unlimited to that disclosed in the above embodiment. For example, the fastener may include only a bolt 41 and a nut 44. The bolt 41 is inserted through the drum combining hole 121 of the drum ring 10, the disc combining hole 24 of the disc 20 and the seat combining hole 34 of the connecting seat 30, and screwed into the nut 44, such that the drum ring 10, the disc 20 and the connecting seat 30 are clamped between the head portion 411 of the bolt 41 and the nut 44. This can also achieve the effect of fastening the drum ring 10, the disc 20 and the connecting seat 30 together.

In conclusion, the drum ring 10 and the connecting seat 30 provided in the present invention can be combined into the drum of the drum-in-hat brake assembly 1. Besides, by the arrangement that the specific gravity of the material of the connecting seat 30 is smaller than the specific gravity of the material of the drum ring 10, such as the arrangement that the connecting seat 30 is made of aluminum alloy and the drum ring 10 is made of cast iron, the drum provided in the present invention, i.e. the combination of the drum ring 10 and the connecting seat 30, is lighter in overall weight than the traditional drum integrally made of cast iron. Besides, the drum ring 10 made of the material with relatively larger specific gravity provides the drum the desired rigidity and wear resistance, so that the objective of the present invention is achieved.

The invention being thus described, it will be obvious that the same may be varied in many ways. Such variations are not to be regarded as a departure from the scope of the invention, and all such modifications as would be obvious to one skilled in the art are intended to be included within the scope of the following claims.

What is claimed is:

1. A drum-in-hat brake assembly comprising:
a drum ring comprising an inner circumferential surface for being abutted by a drum brake shoe, and a plurality of drum combining holes located around the inner circumferential surface;
a disc comprising a central hole, and a plurality of disc combining holes located on an inner wall of the central hole;
a connecting seat comprising a central region for being fastened with an axle bolt, and a plurality of seat combining holes located around the central region, a specific gravity of a material of the connecting seat being smaller than a specific gravity of a material of the drum ring; and
a plurality of fasteners inserted in the drum combining holes of the drum ring, the disc combining holes of the disc, and the seat combining holes of the connecting seat to fixedly combine the drum ring, the disc and the connecting seat fixedly in a way that at least a part of the drum ring is located in the central hole of the disc, and the connecting seat is coupled with the drum ring and has a part located in the central hole of the disc and another part protruding out of the central hole.

2. The drum-in-hat brake assembly as claimed in claim 1, wherein the material of the drum ring is one of cast iron and steel; the material of the disc is one of cast iron, steel and a composite of ceramic and carbon fiber; the material of the connecting seat is aluminum alloy.

3. The drum-in-hat brake assembly as claimed in claim 1, wherein the drum ring comprises a ring body, and a fastening ring plate annularly connected to the ring body and extending horizontally and radially; the inner circumferential surface is provided at the ring body; the drum combining holes penetrate through the fastening ring plate.

4. The drum-in-hat brake assembly as claimed in claim 3, wherein the inner wall of the central hole of the disc has a plurality of protrusions; each of the protrusions has one of the disc combining holes; the fastening ring plate of the drum ring is abutted on the protrusions of the disc in a way that the drum combining holes are aimed at the disc combining holes, respectively.

5. The drum-in-hat brake assembly as claimed in claim 3, wherein the connecting seat comprises a seat tube, and a seat room formed in the seat tube; the ring body of the drum ring is accommodated in the seat room of the connecting seat, and is in contact with an inner surface of the seat tube.

6. The drum-in-hat brake assembly as claimed in claim 1, wherein the disc comprises a plurality of protrusions forming the inner wall of the central hole; the disc combining holes penetrate through the protrusions, respectively.

7. The drum-in-hat brake assembly as claimed in claim 1, wherein the fastener comprises a bolt and a nut; the bolt is inserted through the drum combining hole of the drum ring, the disc combining hole of the disc and the seat combining hole of the connecting seat, and screwed into the nut, so that the drum ring, the disc and the connecting seat are clamped between a head portion of the bolt and the nut.

8. The drum-in-hat brake assembly as claimed in claim 1, wherein the fastener comprises a bolt, a sleeve, a spacer, and a nut; the spacer is clamped between a rear surface of the disc and a front surface of the connecting seat, and comprises a spacer through hole; the sleeve comprises an abutment portion and an insertion portion connected with each other, and a sleeve through hole penetrating through the abutment portion and the insertion portion; the insertion portion of the sleeve is disposed in the disc combining hole, the seat combining hole and the spacer through hole; the bolt comprises a head portion and a rod portion connected with each other; the rod portion is inserted through the sleeve through hole, and comprises a threaded section; the nut is fixedly screwed onto the threaded section, so that the drum ring, the disc, the spacer, the connecting seat and the abutment portion of the sleeve are clamped between the head portion of the bolt and the nut.

9. The drum-in-hat brake assembly as claimed in claim 8, wherein the sleeve of the fastener comprises two grooves formed at the abutment portion; each of the seat combining holes comprises a recess; the recess has an inner bottom surface; an inner edge of the inner bottom surface is accommodated in the groove.

10. The drum-in-hat brake assembly as claimed in claim 8, wherein the sleeve of the fastener comprises two installation planes opposite to each other; the installation planes are accommodated in the seat combining hole of the connecting seat.

11. The drum-in-hat brake assembly as claimed in claim 10, wherein the spacer of the fastener comprises two inner sides formed in the spacer through hole and matched with the installation planes of the sleeve.

12. The drum-in-hat brake assembly as claimed in claim 10, wherein the sleeve of the fastener comprises two bumps formed on the installation planes respectively; the bumps of the sleeve are jammed in the seat combining hole of the connecting seat.
